(19) United States
(12) Patent Application Publication
(10) Pub. No.: US 2015/0360782 A1
(43) Pub. Date: Dec. 17, 2015

(54) AIRCRAFT

(71) Applicant: Sell GmbH, Herborn (DE)

(72) Inventors: Zhao JIN, Everett, WA (US); Jean-Marie DAOUT, Mukilteo, WA (US); Thomas M. LEE, Coto de Caza, CA (US)

(21) Appl. No.: 14/761,057

(22) PCT Filed: Feb. 12, 2014
(86) PCT No.: PCT/EP2014/052754

§ 371 Date: Jul. 15, 2015

Related U.S. Application Data
(60) Provisional application No. 61/764,027, filed on Feb. 13, 2013.

(51) Int. Cl. B64D 11/04; B64D 11/00; B64C 1/18; B64D 11/06

(52) U.S. Cl. CPC B64D 11/04; B64D 11/06; B64D 11/003; B64C 1/18

(57) ABSTRACT

An aircraft has side walls, a floor between the side walls and having an exit area and an exit compartment, a plurality of seats on the floor, a galley on the floor, a plurality of carts movable on the floor inside and outside the galley, and a monument on the floor capable of temporarily containing at least one of the carts. The exit area is capable of temporarily containing another of the carts. The monument has a door through which a person can enter or leave the monument, a further wall section movable between a closed and open position such that in the open position one of the carts can be pushed into the monument, and a slide element for guiding a cart into the and out of the monument past the wall section in the open position thereof.

### CROSS REFERENCE TO RELATED APPLICATIONS

This application is the US-national stage of PCT application PCT/EP2014/052754 filed 12 Feb. 2014 and claiming the priority of U.S. provisional application 61/764,027 filed 13 Feb. 2013.

### FIELD OF THE INVENTION

The present invention relates to an aircraft comprising at least one floor on which a plurality of seats is arranged, wherein furthermore at least one galley and at least one monument, especially a lavatory or a closet or a crew rest area, is arranged on the floor, wherein the floor is laterally delimited by side walls and comprises at least one exit area, wherein the galley comprises a plurality of carts for food and/or is beverages and/or other utensils, wherein the carts are movable on the floor.

### BACKGROUND OF THE INVENTION

Aircraft galleys are well known in the art. The galley comprises a number of carts which can be moved on the floor of the aircraft where the seats as well as the galley are arranged. Currently, each cart (trolley) has its definite location on board; at this location the cart is parked and secured as long as it is not required for food service on board.

Especially, during landing and take-off it is necessary to securely stow all the carts in respective locations to avoid inadmissible movements of the carts. Later on, i.e. during flight, the carts are taken from their location during landing and take-off and can be moved along the aisle to supply passengers with food and beverages. Food and other material which is used in the galley for the preparation of food service are taken out from the carts; the cart itself can remain in this case at a permanent location.

It is a drawback of the existing aircraft galleys that the space within the galley is very limited and constricts the work which has be done in the galley during preparation of food service.

### OBJECT OF THE INVENTION

Thus, it is an object of the present invention to further develop an aircraft design with a galley in such a way that on the one hand side a minimum space is required for the reception of the carts and that on the other hand sufficient space is available during the work in the galley. So, the limited space in an aircraft should be used as efficient as possible.

### SUMMARY OF THE INVENTION

The solution of this object by the invention is characterized in that the monument, especially the lavatory, is designed for temporarily containing at least one cart and the exit area is designed for temporarily containing at least one cart.

The monument (especially the lavatory) can be equipped with a door for entering and leaving of the monument by a person, wherein the monument can have a further wall section which can be opened and closed, wherein the wall section is designed to push in a cart into the monument in the opened state of the wall section. Preferably, at least one slide element is arranged in the monument for guiding the cart into the and out of the monument. Furthermore, is can be provided that the monument comprises at least one second door for preventing the movement of the at least one cart when it is in the monument and when the second door is in a closed state. Also latching means can be arranged to block the movement of the at least one cart when it is in the monument.

Due to hygienic reasons it can be provided that an isolating material is arranged around the at least one cart when it is in the monument to isolate it against the inner of the monument. This is especially important in the case of a lavatory.

Furthermore, the space near the side wall can comprise a compartment for receiving the at least one cart.

Thereby, a table element can be arranged in the or above the compartment. The table element can be arranged pivotable around an axis. So, it can be flapped in an employment position when the carts are arranged in the compartment. During non-use it can be flapped in an upright position.

Also, latching means can be arranged to block the movement of the at least one cart when it is in the compartment.

According to a preferred embodiment of the invention the carts can have a longitudinal axis, wherein the longitudinal axis is perpendicular to an axis of the aircraft (or aisle) when the cart is in the compartment.

At least two carts can be arranged in the monument and/or near at least one of the side walls (i.e. in the compartment), wherein the size of the carts is identical. Alternatively, it can be provided that at least two carts are arranged, wherein the size of the carts is different; in the latter case the size of the smaller cart can be half the size of the bigger cart.

Preferably, the galley is arranged in a center area of the floor.

That is, the invention proposes the concept that for a part of the carts (trolleys) at least one additional location is assigned. According to the demands this additional location is used for other purposes as the case may be. In other words, the idea is basing on the concept to use the emergency exits, i.e. the exit areas, which have to stay free during take-off and landing due to safety reasons, for stowing the carts during flight. During take-off and landing the carts are partially positioned in those areas which cannot be used from by the passengers or the crew during take-off and landing (herein referred to as monuments like the lavatory, a closet, the crew rest area, the cross aisle and others). Thus, a respective cart is moved between the monument area and the exit area.

This concept is basing on the idea that at the one hand areas are provided in the aircraft which are not required during the flight and on the other hand areas are provided in the aircraft which are not required during take-off and landing. Areas, which are no required during take-off and landing are for example the lavatories and the cross aisles (the cross aisles must have only a minimum width for being an emergency exit). During flight the area in front of the exits are not required and thus available for positioning a cart.

So, according to the invention it becomes possible that additional carts can be stowed at a cross aisle or inside a lavatory during the take-off and landing of the aircraft. Then, during flight the carts are relocated into the regions of the exit door areas or when the carts in the center galley need to be pulled out.

Thus, additional work surface can be provided at the cross-aisle and exit door areas if needed.

So, trolleys (carts) can be stowed in the monument during take-off and landing. A sliding compartment on the side of the monument allows to slide the trolleys out. Also trolley holding tables can be employed. The trolleys are then relocated at the exit and held in place via a folding table attached to the bulkhead. In the down position, latches similar to a galley latch holds the trolleys in space. Similarly the bulkhead opposing the galleys can also hold trolleys in place.

For example three half size trolleys can be stowed next to each other at the exit (axis of trolleys perpendicular to the axle of the aisle) or one full size trolley (parallel to the aisle) can be stowed. Also for example six half size trolleys can be stowed next to each other at the bulkhead (axis of trolleys parallel to the aisle) or two full size trolleys (parallel to the aisle).

The additional drop down surface can be used as work surfaces. The drop down surface can be temporarily stowed in an upright position to allow the removal of the trolleys from the opposite galley.

So, the carts can be located and secured in different available areas during certain time intervals of the flight in a flexible manner. Afterward, the carts are moved back so that the area is available again.

Respective holding or fixing devices make sure that a cart is safely secured and blocked in its movements in the exit area during flight. A beneficial solution deals with the mentioned pivotable table element which allows an easy locking and unlocking of the carts in the exit area. The table element is preferably easily secures in the locking and unlocking position to allow a simple handling.

Accordingly, a number of carts can be moved according to the status of the flight (take-off and landing or flight) between the monument, preferably the lavatory or the cross aisle, and the exit area. So, the required place for the carts can be minimized.

### BRIEF DESCRIPTION OF THE DRAWING

In the drawings embodiments of the invention are shown.

FIG. 1 shows a top plan view onto a part of a floor of an aircraft with seats, a

galley and monuments which are lavatories in the present case,

FIG. 2 shows a view onto the galley and the lavatories during take-off and

landing of the aircraft,

FIG. 3 shows a view onto the galley and the lavatories during the flight of the aircraft,

FIG. 4 shows a perspective view of the galley and the lavatories during stowing of some carts of the galley into the lavatories,

FIG. 5a shows a top plan view onto a part of the floor of the aircraft, wherein the movement of some carts is depicted from a position during take-off and landing to a position during flight for half-size carts,

FIG. 5b shows a top plan view onto a part of the floor of the aircraft, wherein the movement of some carts is depicted from a position during take-off and landing to a position during flight for full-size carts,

FIG. 6 shows a top view onto the galley and the lavatories during flight, wherein some carts are in a compartment at the side walls of the floor,

FIG. 7a shows a top view onto the galley and the lavatories showing the minimum aisle width which remains when the carts are stowed,

FIG. 7b shows in the depiction of FIG. 7a an additional drop-down work surface,

FIG. 8a shows a perspective view of the galley, wherein the flip-down work surface is shown in a take-off and landing position and

FIG. 8b shows a perspective view of the galley, wherein the flip-down work surface is shown in a flight position during use.

### SPECIFIC DESCRIPTION OF THE INVENTION

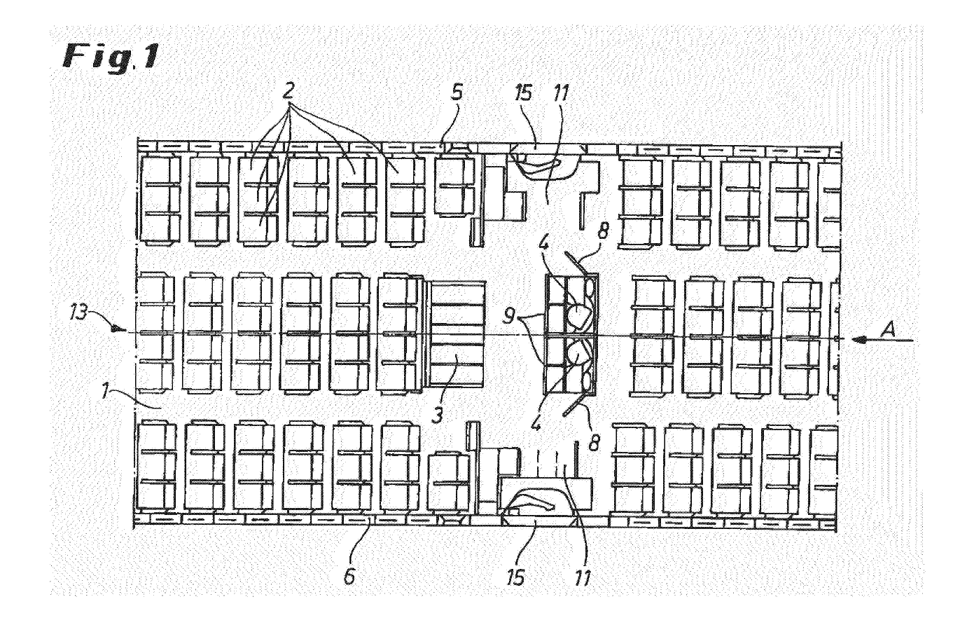

In FIG. 1 a top plan view of an aircraft floor 1 is shown; on the floor 1 a plurality of seats 2 is arranged in known manner. The floor 1 is delimited laterally by side walls 5 and 6.

The floor 1 has an axis A which extends in the longitudinal direction of the aircraft.

Furthermore, a galley 3 is arranged in the center area 13 of the floor 1. Opposite to the galley 3 but close to the same two lavatories 4 are arranged. Each lavatory 4 has its door 8 (for example) in a lateral region. The side of the lavatories 4 which is facing the galley 3 has a wall section 9.

In the regions of the side walls 5, 6 and near the galley 3 compartments 11 are arranged which are located in front of exits 15. The exits must remain free during take-off and landing but are in general free space during flight which needs not necessarily to stay free.

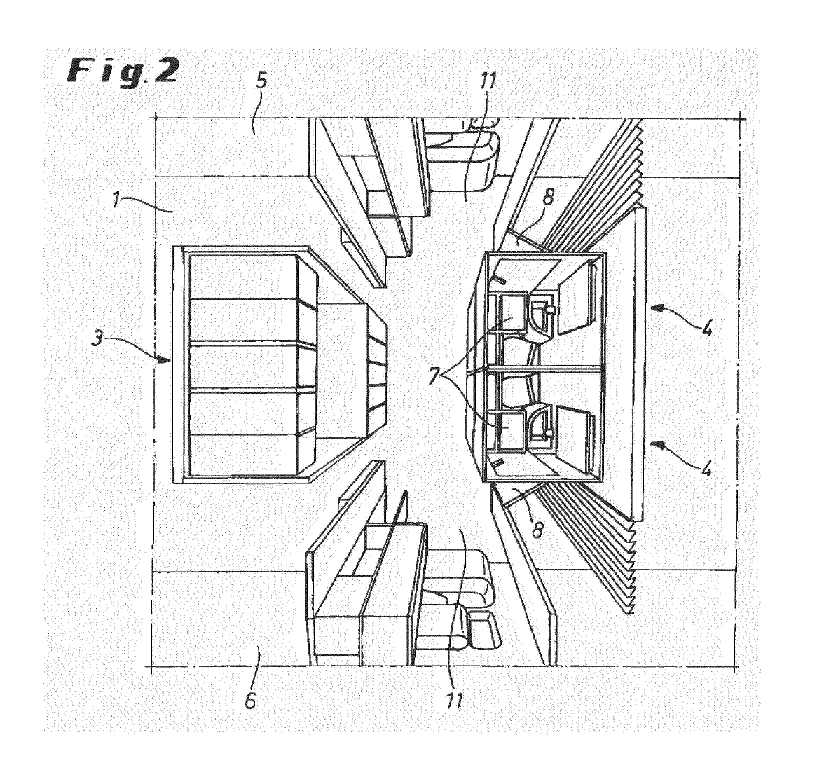

The situation during take-off and landing is depicted in FIG. 2. Here is can be seen that carts 7 (trolleys) for stowing galley stuff (food, beverage, etc.) are located temporarily in the lavatories 4. More specifically, three half carts 7 are located in both of the lavatories 4.

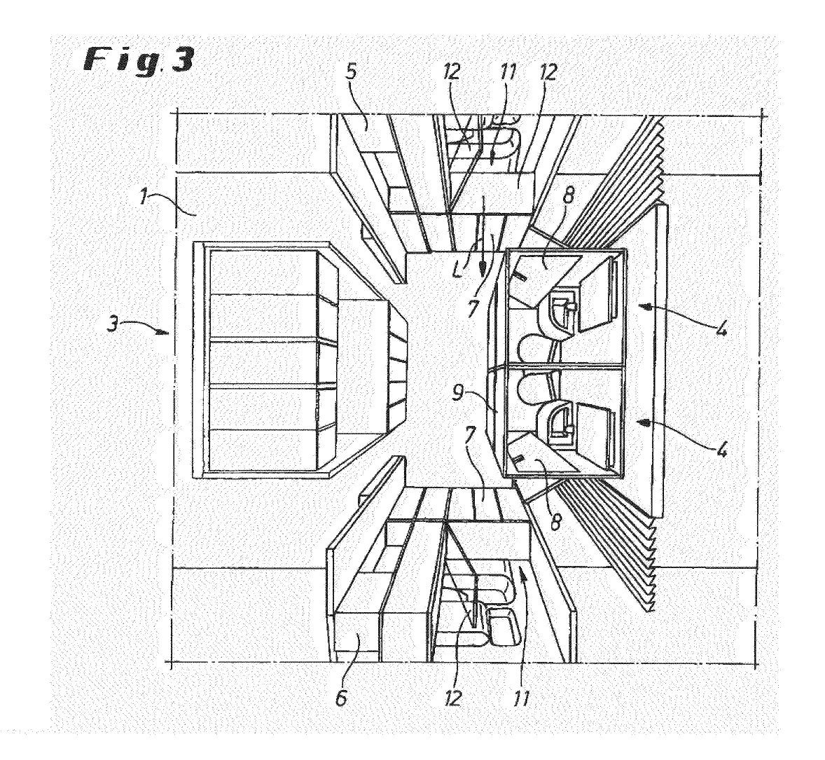

In FIG. 3 it can be seen that the carts 7 have been moved from the lavatories 4 into the compartments 11 to establish the arrangement for the flight. In this FIG. it can further be seen that a table element 12 is arranged in the compartment 11. The table is arranged pivotable. In FIG. 2 for sake of illustration the upright position of the table element 12 is depicted as well as the employment position in which the table element 12 is pivoted down and in which it covers the upper side of the carts 7. When the table elements 12 are flapped down onto the carts 7 the latter are secured in its position and cannot move.

FIG. 3 also shows the orientation of the carts 7 when they are in the compartment 11. The longitudinal axis L of the cart 7 is perpendicular to the axis A (see FIG. 1) in this embodiment when the carts 7 are located in the compartment 11.

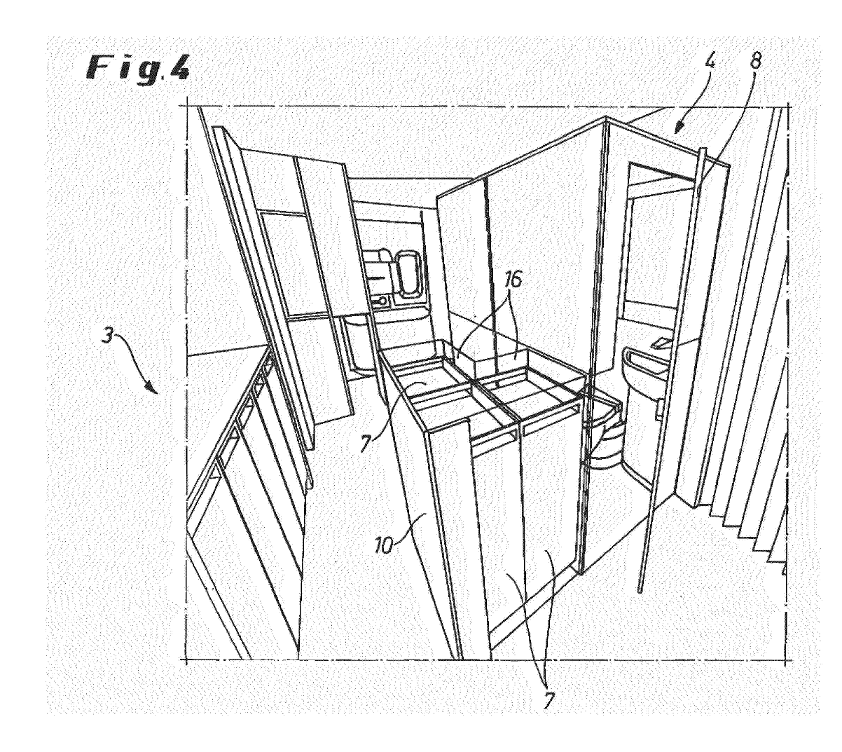

In FIG. 4 it is shown that the lavatories 4 have a second door 10 (movable wall) which can be opened to push in the carts 7 into the lavatory 4. In the FIG. it can be seen that three carts 7 are located with the second door 10 open in a slidable arrangement (not depicted) which is inserted into the lavatory 4 by closing the second door 10. The carts 7 are protected and hygienically isolated by a cover element 16 before they are located behind the second door 10 and pushed into the lavatory 4. The cover element is custom contoured to fit with the shape of the carts 7 which have to be located in the lavatory 4.

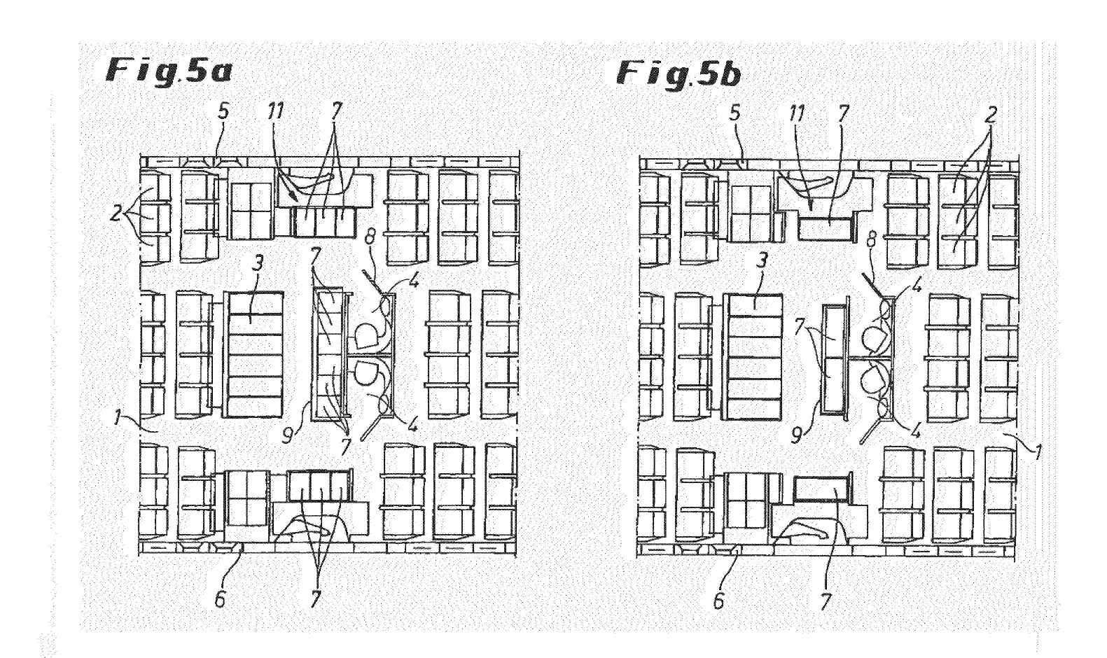

FIG. 5 shows the movement—marked by arrows—of the carts 7 from the take-off and landing position in the lavatories 4 to the compartments 11 at the side walls 5 and 6. FIG. 5a shows half-size carts 7, while FIG. 5b shows full-size carts 7.

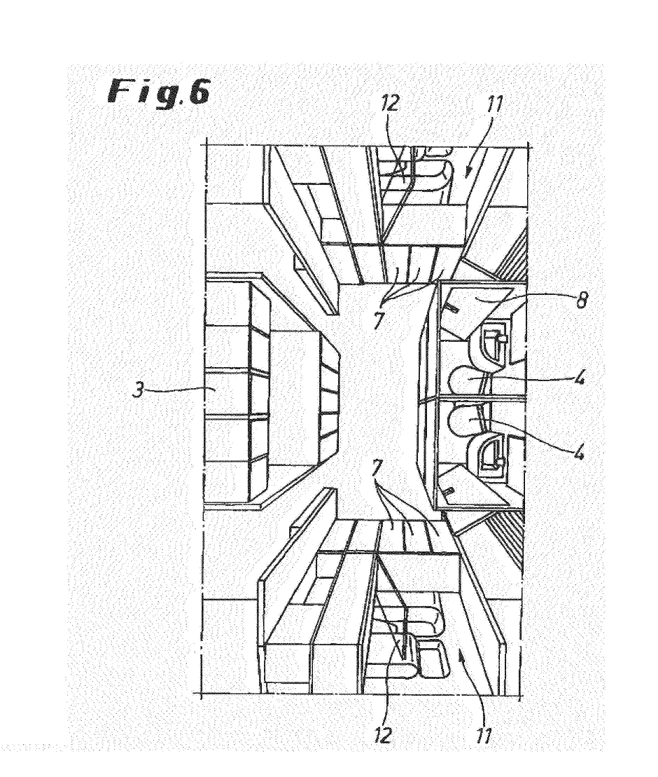

In FIG. 6 it can be seen again how three carts 7 are located in each compartment 11 and are then covered by the table element 12. The lavatories 4 are ready to be used by the passengers.

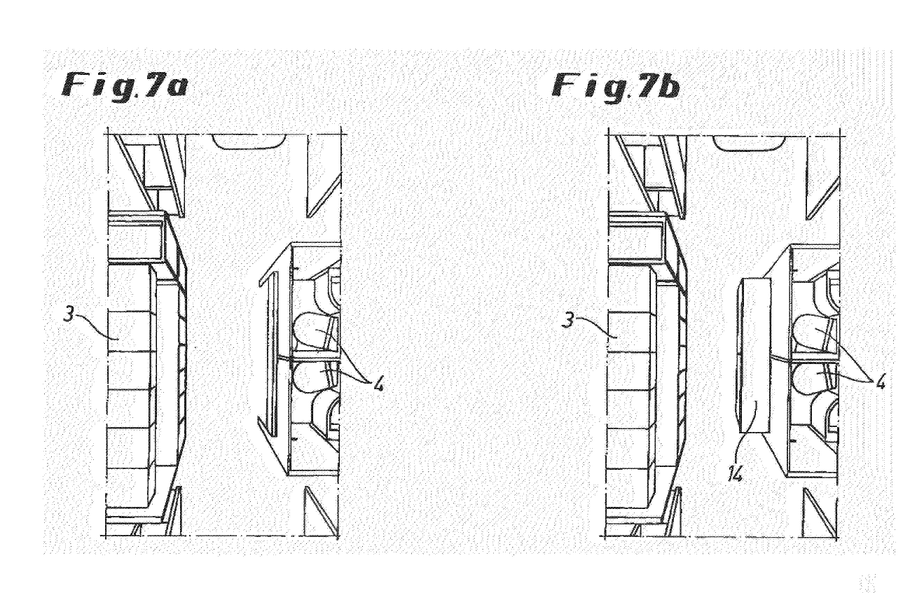

FIG. 7a shows the aisle between the galley front and the lavatories 4 after the carts 7 have been moved to the compartment 11. Thus the minimum aisle width can be seen which remains when the carts 7 are stowed in the compartments 11.

In FIG. 7b is can be seen that a work surface 14 is brought in deployment position after the carts 7 have been transferred. The work surface 14 is arranged pivotable. The work surface 14 acts as a fixation device for locking the carts 7 when they are located below the work surface 14 (similar to the function of the table element 12). So, carts 7 can be securely arranged temporarily in the cross aisle.

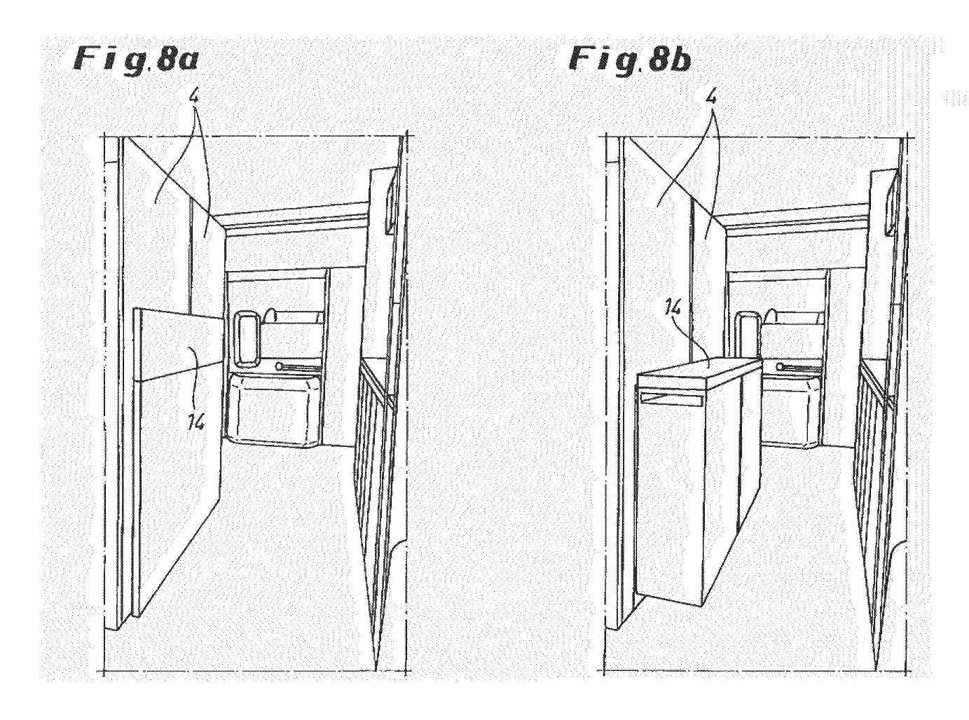

This is also depicted in FIG. 8a (where the work surface 14 is in a stowed position) and in FIG. 8b (where the work surface 14 is in a deployment position). Thus, the work surface 14 can be used during flight (as the table element 12).

Of course, when using a respective locking device the table element 12 as well as the work surface 14 can also be used without carts 7 arranged below them.

Due to the proposed concept additional stowing space is created for the galley. So, at another location space for arranging additional seats is developed. The degree of utilization of the aircraft can thus be enhanced, i.e. more passengers can be transported.

1-15. (canceled)

16. An aircraft comprising:
side walls;
a floor between the side walls and having an exit area and an exit compartment;
a plurality of seats on the floor;
a galley on the floor;
a plurality of carts movable on the floor inside and outside the galley; and
a monument on the floor capable of temporarily containing at least one of the carts, the exit area being capable of temporarily containing another of the carts, the monument having
a door through which a person can enter or leave the monument,
a further wall section movable between a closed and open position such that in the open position one of the carts can be pushed into the monument, and
a slide element for guiding a cart into the and out of the monument past the wall section in the open position thereof.

17. The aircraft defined in claim 16, wherein the monument further has:
at least one second door engageable and preventing movement of a cart when it is inside the monument and the second door is in a closed position.

18. The aircraft defined in claim 16, wherein the monument further has:
latch means for blocking movement of a card inside the monument.

19. The aircraft defined in claim 16, wherein the exit area is near one of the side walls and forms a storage compartment for receiving one of carts.

20. The aircraft defined in claim 19, wherein the exit area has a table in or above the storage compartment.

21. The aircraft defined in claim 21, wherein the table is pivotable around an axis.

22. The aircraft defined in claim 19, wherein the monument further has:
latch means for blocking movement of a card inside the storage compartment.

23. The aircraft defined in claim 19, wherein each of the carts is elongated parallel to a cart longitudinal axis and a cart in the compartment has its longitudinal axis parallel to the side walls.

24. The aircraft defined in claim 16, wherein the carts are all of substantially identical size and at least two of the carts fit inside the monument.

25. The aircraft defined in claim 16, wherein at least two of the carts of different sizes fit inside the monument.

26. The aircraft defined in claim 16, wherein at least two of the carts of different sizes fit against one of the side walls.

27. The aircraft defined in claim 25, wherein of the two carts of different sizes, one is half the size of the other.

28. The aircraft defined in claim 16, wherein the galley is centered in the floor and completely surrounded by the seats
